(19) United States
(12) Patent Application Publication
(10) Pub. No.: US 2016/0347031 A1
(43) Pub. Date: Dec. 1, 2016

(54) VEHICULAR INTERIOR PART

(71) Applicant: TOYOTA BOSHOKU KABUSHIKI KAISHA, Aichi-ken (JP)

(72) Inventors: Kazuhiro TAWADA, Aichi-ken (JP); Kenji OKAMOTO, Aichi-ken (JP); Sadayuki KAWATA, Aichi-ken (JP); Kenji KIYOSAWA, Aichi-Ken (JP); Jun ISAMI, Aichi-ken (JP); Yousuke TAGAMI, Gifu-ken (JP)

(73) Assignee: TOYOTA BOSHOKU KABUSHIKI KAISHA, Aichi-ken (JP)

(21) Appl. No.: 15/153,883

(22) Filed: May 13, 2016

(30) Foreign Application Priority Data
May 27, 2015 (JP) 2015-106932

(51) Int. Cl. B32B 5/20; B62D 25/06; B32B 3/30; B32B 5/02; B32B 5/24

(52) U.S. Cl. CPC B32B 5/20; B32B 5/022; B32B 5/245; B32B 3/30; B62D 25/06; B32B 2250/03; B32B 2255/02; B32B 2266/025; B32B 2262/101; B32B 2605/003

(57) ABSTRACT

A vehicular interior part includes a porous fiber base member made of an inorganic fiber sheet, thermoplastic resin, and a foaming agent, a skin attached on one surface of the porous fiber base member and constitutes a design surface, and a mold portion included in a part of the porous fiber base member and the skin that are attached to each other, the mold portion having a recess portion on a skin surface side and a projection portion on a side opposite from the skin surface side, the recess portion having an opening on the design surface and having a depth equal to or greater than an opening width of the recess portion.

### CROSS REFERENCE TO RELATED APPLICATION

This application claims priority from Japanese Patent Application No. 2015-106932 filed on May 27, 2015. The entire contents of the priority application are incorporated herein by reference.

### FIELD OF THE INVENTION

The present disclosure relates to a vehicular interior part.

### BACKGROUND OF THE INVENTION

There has been a ceiling interior part that has a sheet shape and is mounted on a roof panel of a vehicle from a vehicular interior side. The roof panel constitutes a part of a ceiling of a vehicle. The roof interior part includes a base sheet and a sheet of skin that is adhered on the base sheet from the vehicular interior side. The ceiling interior part is molded into a predetermined shape with using a mold.

A thermosetting urethane foam base is one example of the base sheet of the ceiling interior part.

### SUMMARY OF THE INVENTION

The present technology has been made in view of the aforementioned circumstances. An objective of the present technology is to provide a vehicular interior part having a recess portion that is used for decoration or mounting of parts.

A technology described herein relates to a vehicular interior part including a porous fiber base member made of an inorganic fiber sheet, thermoplastic resin, and a foaming agent, a skin attached on one surface of the porous fiber base member and constitutes a design surface, and a mold portion included in a part of the porous fiber base member and the skin that are attached to each other, the mold portion having a recess portion on a skin surface side and a projection portion on a side opposite from the skin surface side, the recess portion having an opening on the design surface and having a depth equal to or greater than an opening width of the recess portion.

### BRIEF DESCRIPTION OF THE DRAWINGS

FIG. 1 is a plan view schematically illustrating a ceiling of a vehicular interior according to a first embodiment.

FIG. 2 is a perspective view illustrating a part of a ceiling interior part seen from a rear surface side.

FIG. 3 is a cross-sectional view taken along line III-III in FIG. 2.

FIG. 4 is a cross-sectional view illustrating a mold portion.

FIG. 5 is a graph illustrating results of a tension test carried out for the ceiling interior part.

FIG. 6 is a plan view illustrating a mold portion of a ceiling interior part according to a second embodiment seen from a design surface side.

FIG. 7 is a perspective view illustrating the mold portion of the ceiling interior part according to the second embodiment seen from a rear surface side.

FIG. 8 is a cross-sectional view of the mold portion and a decoration member held in a recess portion of the mold portion according to the second embodiment.

FIG. 9 is a cross-sectional view of a mold portion and a light guide light member held in a recess portion of the mold portion according to a third embodiment.

FIG. 10 is a perspective view illustrating a ceiling interior part seen from a design surface side according to a fourth embodiment.

FIG. 11 is a perspective view illustrating the ceiling interior part seen from a rear surface side according to the fourth embodiment.

FIG. 12 is a cross-sectional view taken along line XII-XII in FIG. 11.

FIG. 13 is a cross-sectional view illustrating a ceiling interior part and a lighting device where a flange of the lighting device is mounted on a projection portion formed on a rear surface of the ceiling interior part.

### DETAILED DESCRIPTION OF EMBODIMENTS

A vehicular interior part such as a ceiling interior part is molded so that an entire shape thereof has a shape following a shape of a roof panel that is an object on which the ceiling interior part is mounted.

A thermosetting base member made of urethane foam is less likely to be molded freely. For example, a deep recess is less likely to be formed on a design surface of the vehicular interior part for decoration or mounting of parts.

### First Embodiment

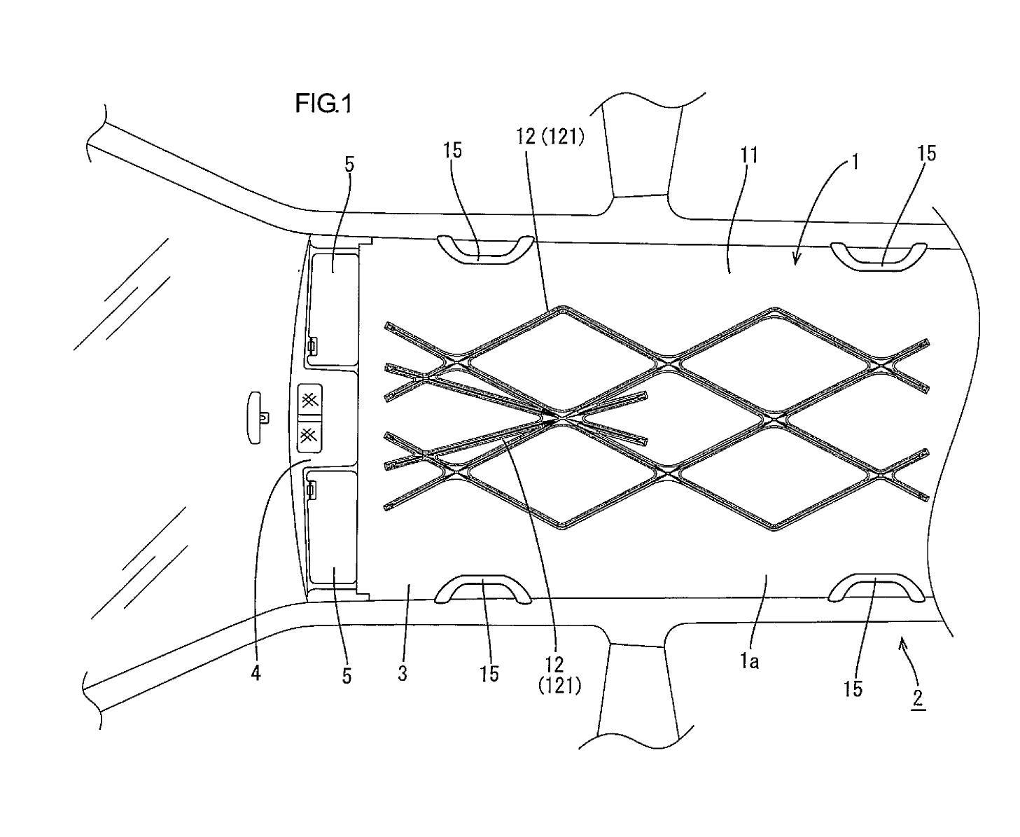

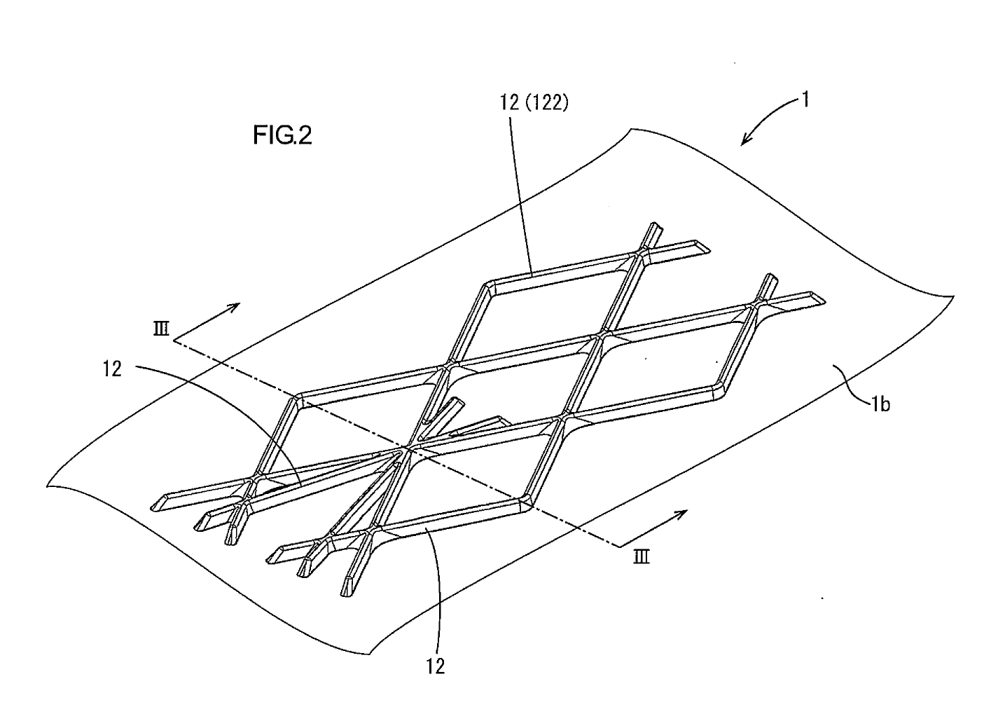

One embodiment will be described with reference to FIGS. 1 to 5. In this embodiment, a ceiling interior part (a head liner) 1 will be described as an example of a vehicular interior part. FIG. 1 illustrates a ceiling 3 of a vehicle seen from a vehicular interior 2 side.

The ceiling 3 of the vehicular interior 2 includes a roof panel (not illustrated) and the ceiling interior part 1 that is disposed over the roof panel from the vehicular interior side. In FIG. 1, a left side corresponds to a vehicular front side and a right side corresponds to a vehicular rear side. An upper-loser direction in FIG. 1 corresponds to a right-left direction (a vehicular width direction). As illustrated in FIG. 1, the ceiling 3 includes an overhead console 4 including a vehicular interior light in a vehicular front and middle portion. Sun-visors 5 are disposed on respective sides of the overhead console 4. Assist grips 15 are arranged on a periphery of the ceiling interior part 1.

The ceiling interior part 1 has a sheet shape as a whole so that the roof panel is covered with the ceiling interior part 1. The ceiling interior part 1 includes a main sheet portion 11 that is substantially flat and mold portions 12. The mold portions 12 have deep recess portions 121 that are open at a design surface la of the ceiling interior part 1. The ceiling interior part 1 has the design surface 1a having the recess portions 121 and facing the vehicular interior side. The ceiling interior part 1 has a rear surface 1b that is opposite from the design surface 1a and faces a vehicular exterior side and is opposite the roof panel.

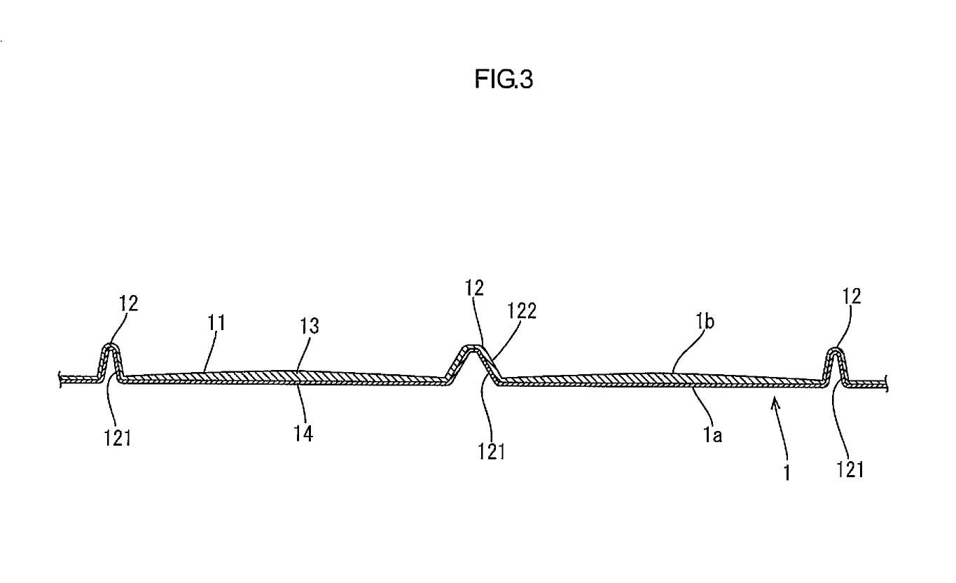

As illustrated in FIG. 3, the mod portions 12 are molded with using a predetermined mold (cold press molding). The mold portion 12 is recessed from the design surface 1a and is projected from the rear surface 1b. The mold portion 12 includes the recess portion 121 and a projection portion 122. The recess portion 121 is a deep recess having an opening on the design surface 1a, and the projection portion 122 is on the rear surface 1b.

As illustrated in FIG. 1, the ceiling interior part 1 includes the mold portions 12 on an entire area of the design surface 1a (a ceiling surface of the vehicular interior 2), and the mold portions 12 are arranged in substantially a grid. The mold portions 12 provide design of the ceiling 3 in the vehicular interior 2.

The mold portions 12 include deep long recesses 121 that are deep long grooves and the deep long recesses 121 cross each other on the design surface 1a.

Before press molding, a thermoplastic expansion fiber sheet includes an inorganic fiber sheet containing non-woven glass fibers (an example of inorganic fiber) to which polypropylene (an example of thermoplastic. resin) and foaming agents are added. The skin 14 is attached to the thermoplastic expansion fiber sheet via an adhesive layer. The thermoplastic expansion fiber sheet and the skin 14 that are attached to each other constitute an unmolded base member. The unmolded base member is thermally expanded by pre-heating and then, the thermally expanded base member is molded into a predetermined shape with cold press molding using a mold (a projection mold and a recessed mold) to obtain the ceiling interior part 1. The thermoplastic expansion fiber sheet is heated and thermally expanded and a porous fiber base member 13 is obtained. Thus obtained ceiling interior part 1 includes the porous fiber base member 13 and the skin 14.

The porous fiber base member 13 is obtained by expanding the thermoplastic expansion fiber sheet and is included in the ceiling interior part 1 on the rear surface 1b side. A sheet of the skin 14 is included in the ceiling interior part 1 on the design surface 1a side.

Examples of the inorganic fiber used for the thermoplastic expansion fiber sheet include glass fiber, carbon fiber, metal fiber, ceramic fiber, natural fiber, or other fiber. Glass fiber may be preferable for the inorganic fiber because the mold portion 12 are easily molded into a predetermined shape.

A plastic film such as a polyethylene terephthalate film may be layered on one surface or both surfaces of the thermoplastic expansion fiber sheet.

The thermoplastic expansion fiber sheet before the heating process may be compressed to have a thickness of several millimeters.

The thermoplastic resin added to the inorganic fiber sheet is binder resin and holds the porous fiber base member 13 in a predetermined shape. Examples of the thermoplastic resin include polypropylene, and polyethylene resin such as polyethylene, ethylene vinyl chloride copolymer, and ethylene-vinyl acetate copolymer.

The foaming agent added to the inorganic fiber sheet may be preferably heat foaming agent that is foamed by heating. The heat foaming agent may not be particularly limited but may be a microsphere obtained by encapsulating hydrocarbon such as isobutene, propane, and pentane in an elastic shell. The hydrocarbon is an example of material that is easily gasified and expanded by heating.

Other examples of the heat foaming agent include inorganic heat foaming agent and organic heat foaming agent. Examples of the inorganic heat foaming agent include ammonium carbonate, ammonium hydrogencarbonate, sodium hydrogencarbonate, ammonium nitrate, sodium borohydride, and azide. Examples of the organic heat foaming agent include water; alkane fluoride such as trichloro-monofluoromethane, dichloromonofluoromethane; azo compound such as azobisisobutyronitrile, azodicarbonamide, barium azodicarboxylate; hydrazine compound such as p-toluenesulfonyl hydrazide, diphenylsulfone-3,3′-disulfonyl hydrazide, 4,4-oxybis(benzenesulfonyl hydrazide), allylbis(sulfonylhydrazide); semicarbazide compound such as p-toluylene sulfonylsemicarbazide, 4,4′-oxybis(benzenesulfonyl semicarbazide); triazole compound such as 5-morpholyl-1,2,3,4-thiatriazole; N-nitroso compound such as N,N′-dinitrosopentamethylenetetramine, N,N′-dimethyl-N,N′-dinitrosoterephthalamide.

Material of the skin 14 has flexibility so that the skin 14 is molded into a predetermined shape together with the porous fiber base member 13. Examples of the material of the skin 14 may be non-woven cloth, polyvinyl chloride leather sheet and elastomer sheet. Material of the skin 14 may be stretched easier (have greater expansion rate) than that of the porous fiber base member 13. The skin 14 has a thickness smaller than that of the porous fiber base member 13.

The porous fiber base member 13 may contain additives such as antioxidants, ultraviolet ray absorbing agents, lubricants, frame retardants, pigments as long as the object of the invention is achieved.

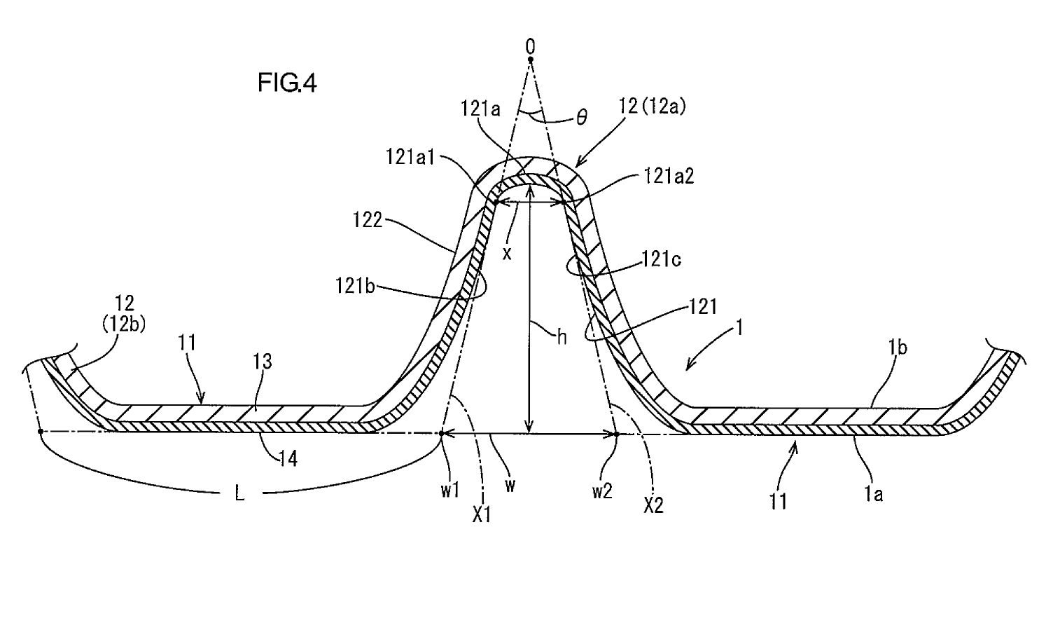

As illustrated in FIG. 4, the ceiling interior part 1 includes the mold portion 12 on the design surface 1 a and the recess portion (groove portion) 121 of the mold portion 12 has a depth h that is equal to or greater than an opening width w of the recess portion 121.

The depth h of the recess portion 121 is a vertical distance from an extension line from the design surface 1a of the main sheet portion 11 to a bottom portion 121a of the recess portion 121. As illustrated in FIG. 4, the bottom portion 121a of the recess portion 121 has an arched shape projecting upward. The depth h of the recess portion 121 is a distance from a tip end of the arched bottom portion 121a to the extension line from the design surface 1a. The depth h of the recess portion 121 is much greater than a thickness of the ceiling interior part 1 or a thickness of the main sheet portion 11.

The recess portion 121 includes the bottom portion 121a and side wall portions 121b, 121c that are opposite each other and each of the side wall portions 121b, 121c continuously extends from the bottom portion 121a. The arched bottom portion 121a has basal points 121a1, 121a2 as illustrated in FIG. 4. As illustrated in FIG. 4, the bottom portion 121a has a bottom width x that is a distance between the basal points 121a1 and 121a2.

As illustrated in FIG. 4, a line X1 extends from the left basal point 121a1 of the bottom portion 121a along the left side wall portion 121b so as to be in contact with a wall surface thereof, and the line X1 crosses the extension line of the design surface 1a at a crossing point w1. A line X2 extends from the right basal point 121a2 of the bottom portion 121a along the right side wall portion 121c so as to be in contact with a wall surface thereof, and the line X2 crosses the extension line of the design surface 1a at a crossing point w2. The opening width w of the recess portion 121 is a distance between the crossing point w1 and the crossing point w2.

As illustrated in FIG. 4, the line X1 and the line X2 crosses at a crossing point O. The lines X1 and X2 form an angle θ of 40 degrees or less.

The bottom width x, the depth h, and the opening width w of the recess portion 121 are set to satisfy a following relational expression 1. If the relational expression 1 is satisfied, the mold portions 12 having a predetermined shape are surely formed in the ceiling interior part 1. The bottom width x is smaller than the opening width w (x<w). According to such a configuration, any utility part is easily mounted in the recess portion 121.

Relational expression 1

(x+2 h)/2≦1.67w 1

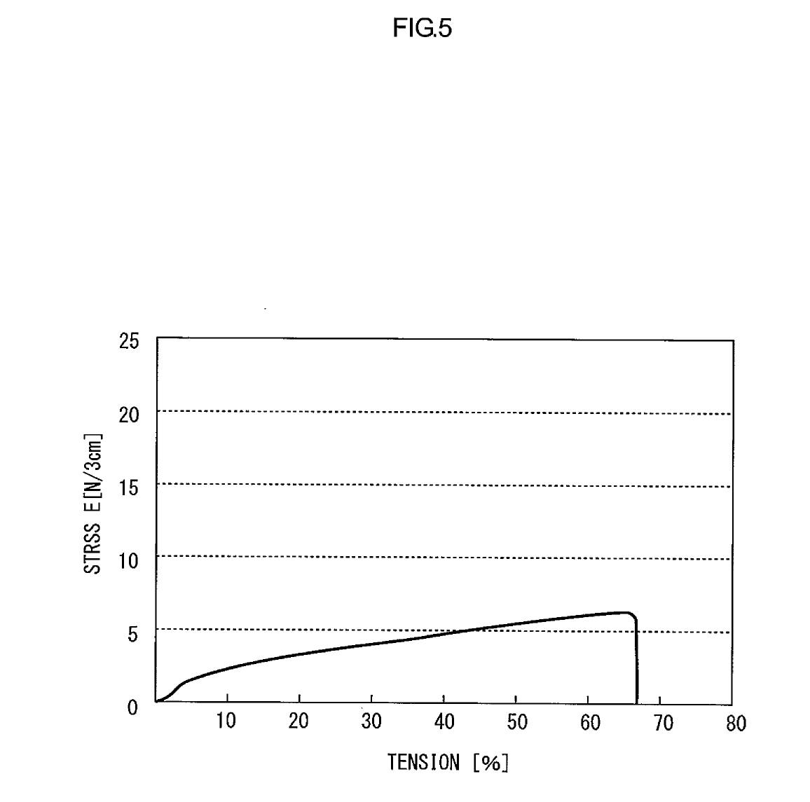

A test sample made of material same as that of the ceiling interior part 1 (250 mm long×30 mm wide×3.5 mm thickness) is prepared for a tension test. The test sample was tensioned with using a tension testing instrument (Instron testing instrument) under certain condition and an extension rate (%) of the test sample was obtained. Under the certain condition, the tension speed is 200 mm/min., and atmosphere temperature is 180° C. The results of the tension test are described in FIG. 5. In FIG. 5, a horizontal axis represents the tension of the test sample (the tension rate) (%) and a vertical axis represents a stress (N/3 cm) of the test sample. As illustrated in FIG. 5, the ceiling interior part 1 (the test sample) was stretched to have a size 1.67 times of an original size.

The left side of the relational expression 1 (x+2 h)/2 approximately represents a stretched amount that is difference between a size dimension of the ceiling interior part 1 before the molding and that after the molding. The right side of the relational expression 1 (1.67 w) represents a maximum size of the opening width w.

Multiple mold portions 12 may be formed in the ceiling interior part 1. For example, as illustrated in FIG. 4, one mold portion 12a is disposed away from another mold portion 12b at a certain interval L. In such a configuration, the certain interval L is set to satisfy a following relational expression 2. If the relational expression 2 is satisfied, the mold portions 12 of the certain shape are surely formed at the certain intervals L in the ceiling interior part 1.

Relational expression 2

L≧(x+2 h−1.67 w)/1.2 2

The distance (interval) between the one mold portion 12a and the other mold portion 12b (an adjacent mold portion) is defined by the relational expression 2. In molding the recess portion 121 of the mold portion 12a, the unmolded base member is pressed so that a portion thereof where the mold portion 12a is to be formed is stretched. The portion of the unmolded base member corresponds to the opening width w. According to the stretching, the main sheet portion 11 between the mold portion 12a and the adjacent mold portion 12b is also tensioned and stretched. The distance L required to surely form the recess portions 121 of the mold portions 12 is defined by the relational expression 2.

The relational expression 2 is obtained based on the tension caused in a half of the recess portion 121 (for example, a left half of the recess portion 121 in FIG. 4) and the tension caused in the main sheet portion 11 adjacent to the recess portion 121 (L≧{(x+2 h/2−1.67×(w/2)}/0.6).

The mold portions 12 having the recess portions 121 are formed in the ceiling interior part 1 so that three dimensional patterns appear on the ceiling interior part 1 and design of the ceiling interior part 1 is improved.

The ceiling interior part 1 including the mold portions 12 enhances rigidity thereof. A decoration member or a utility part is easily mounted in and removed from the recess portion 121 of the mold portion 12 without using fixing members such as screws. Any fixing member is not necessary to be mounted from the rear surface 1 b side to fix a decoration member or a utility part to the ceiling interior part 1 and therefore, the decoration member or the utility part is mounted in and removed from the recess portion 121 easily even after the ceiling interior part 1 is mounted on the roof panel.

### Second Embodiment

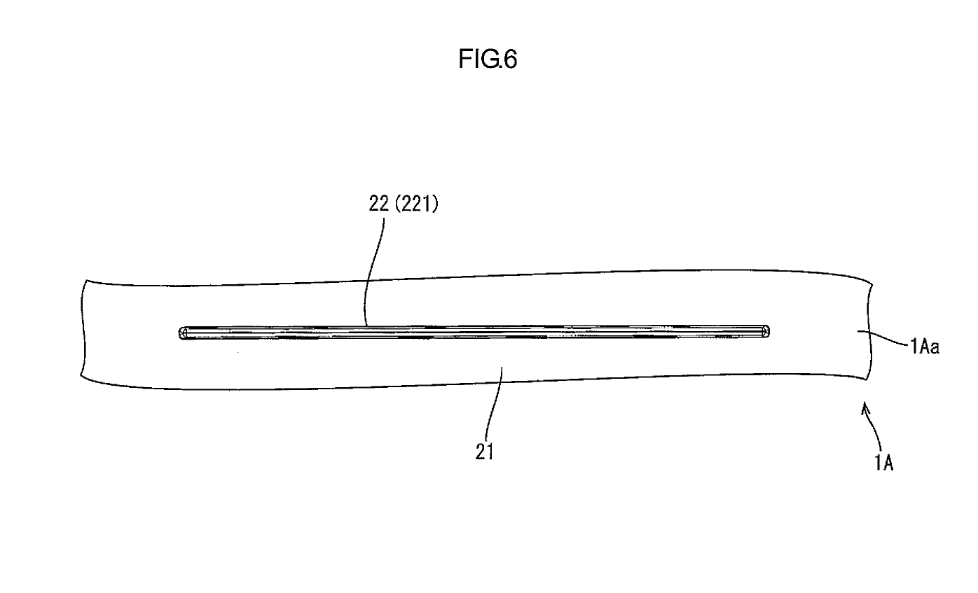

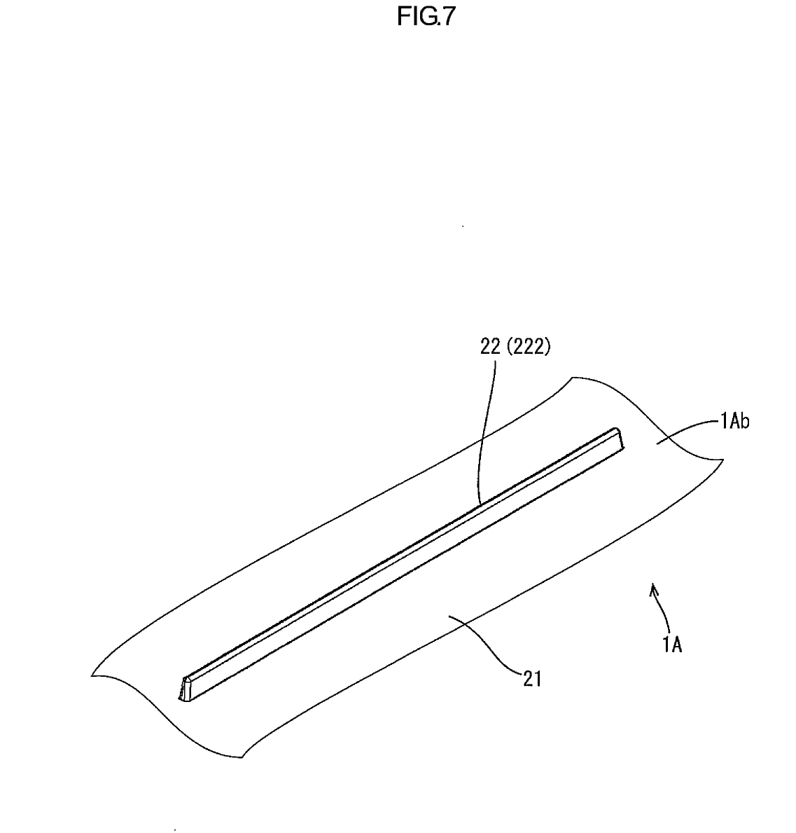

Next, a second embodiment according to the present technology will be described with reference to FIGS. 6 to 8. In this embodiment, a ceiling interior part 1A of a vehicle will be described similarly to the first embodiment. Similarly to the first embodiment, the ceiling interior part 1A of this embodiment includes the porous fiber base member 13 on a rear surface 1Ab side and the skin 14 sheet on a design surface 1Aa side. The porous fiber base member 13 is obtained by expanding a thermoplastic expansion fiber sheet.

The ceiling interior part 1A includes a mold portion 22 having a deep recess portion 221 that is open on a design surface 1Aa. The mold portion 22 has a projection portion 222 on a rear surface 1Ab of the ceiling interior part 1A.

The mold portion 22 of this embodiment has a thin elongated shape extending in a vehicular front-rear direction and the recess portion 221 also has a thin elongated shape extending in the vehicular front-rear direction. The recess portion 221 of the mold portion 22 of this embodiment holds a decoration member 6 therein.

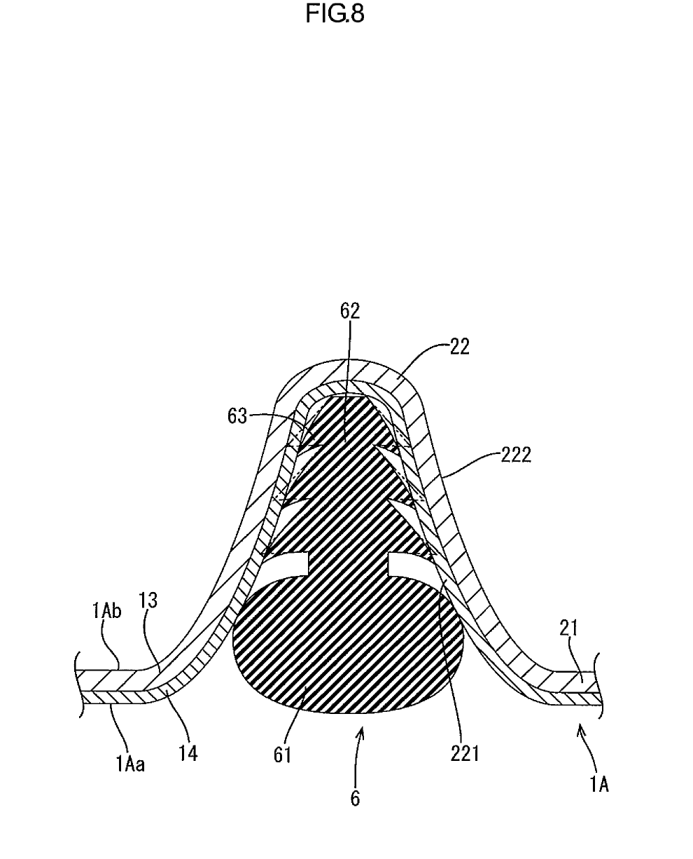

As illustrated in FIG. 8, the decoration member 6 is put in the recess portion 221 of the mold portion 22 and held therein. FIG. 8 illustrates a cross-sectional view of the mold portion 22 and the decoration member 6 cut along a vehicular width direction.

The decoration member 6 may be a molding and has an elongated shape similar to that of the mold portion 22. The decoration member includes a decoration portion 61 having a columnar shape and a mount portion 62 that is continuous from the decoration portion 61. The decoration portion 61 is uncovered and exposed on the design surface 1Aa through opening of the recess portion 221. The mount portion 62 is mounted in the recess portion 221. The mount portion 62 extends along the elongated decoration portion 61. The mount portion 62 includes catching portions 63 that catch a wall surface of the recess portion 221. The decoration member 6 is made of hard rubber or plastic material.

In this embodiment, the decoration member 6 is held in the recess portion 221 of the mold portion 22. Accordingly, the decoration member 6 is directly mounted on the ceiling interior part 1A and mounting parts for mounting the decoration member 6 on the ceiling interior part 1A are not necessary. The decoration member 6 is easily mounted in the recess portion 221 of the mold portion 22. Further, the decoration member 6 is easily mounted in and removed from the recess portion 221 even after the ceiling interior part 1 is mounted on the roof panel.

### Third Embodiment

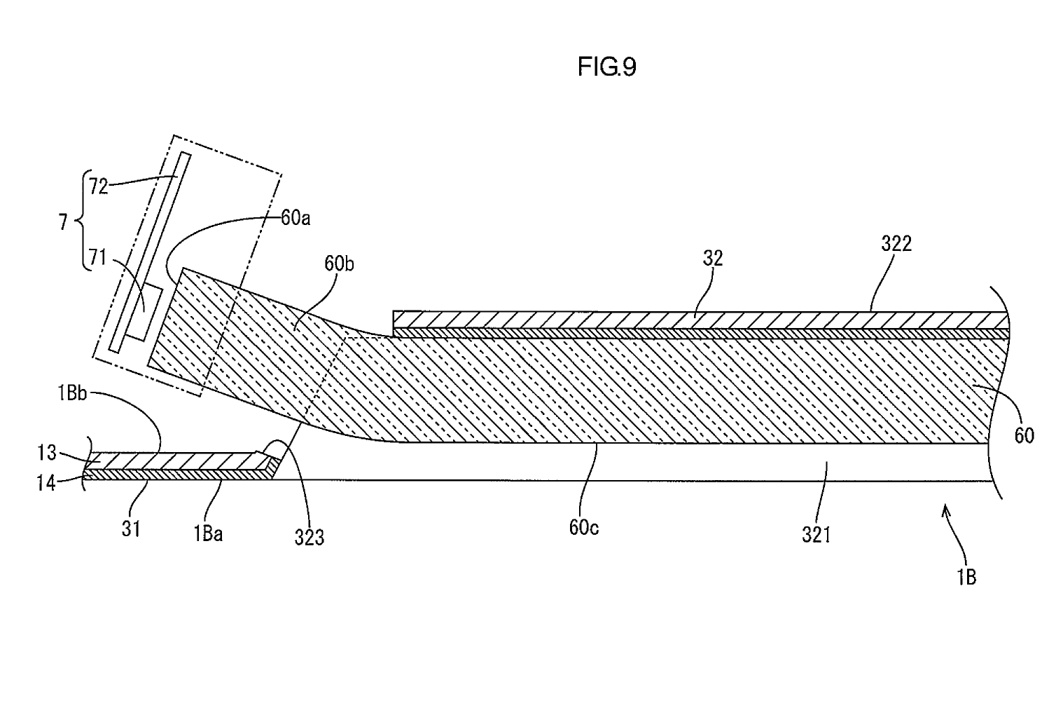

Next, a third embodiment according to the present technology will be described with reference to FIG. 9. In this embodiment, a ceiling interior part 1B of a vehicle will be described similarly to the first embodiment. Similarly to the first embodiment, the ceiling interior part 1B of this embodiment includes the porous fiber base member 13 on a rear surface 1Bb side and the skin 14 sheet on a design surface 1Ba side. The porous fiber base member 13 is obtained by expanding a thermoplastic expansion fiber sheet.

As illustrated in FIG. 9, in this embodiment, a light guide member 60 is mounted and held in a recess portion 321 of a mold portion 32. Similarly to the second embodiment, the ceiling interior part 1B includes an elongated mold portion 32 extending in the vehicular front-rear direction. The mold portion 32 includes an elongated recess portion 321 on a design surface 1Ba and an elongated projection portion 322 on a rear surface 1Bb.

In this embodiment, unlike the second embodiment, the elongated mold portion 32 has a through hole 323 in an end portion thereof. The mold portion 32 holds the elongated (columnar) light guide member 60 (one example of a decoration member) in the recess portion 321. The light guide member 60 has flexibility.

The light guide member 60 is made of acrylic resin. Light enters the light guide member 60 through an end surface 60a and travels within the light guide member 60 in the elongated direction and exits from the light guide member 60 through a peripheral surface toward outside. The light guide member 60 is mounted in the recess portion 321 of the mold portion 32 with pressure. The light guide member 60 is held within the recess portion 321.

The end portion 60b of the light guide member 60 is through the through hole 323 and on the rear surface 1Bb side. The end portion 60b is outside the recess portion 321. The end portion 60b has an end surface 60a that is opposite an LED (light source) 71 of a light source device 7. Light emitted by the LED 71 enters the light guide member 60 through the end surface 60a and the light is exited from the light guide member 60 through the peripheral surface 60c toward a vehicular interior. The LED 71 that is mounted on an LED board 72 is arranged on the rear surface 13Bb side of the ceiling interior part 1B.

In this embodiment, the light guide member 60 is held in the recess portion 321 of the mold portion 32. Accordingly, separate parts for holding the light guide member 60 are not necessary and the light guide member 60 is easily mounted in and removed from the recess portion 321.

### Fourth Embodiment

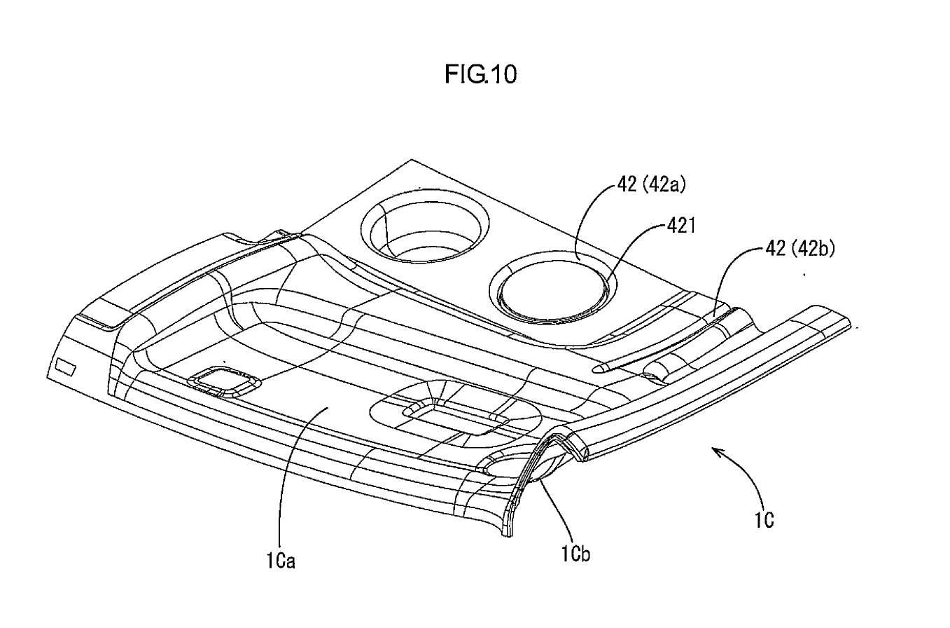

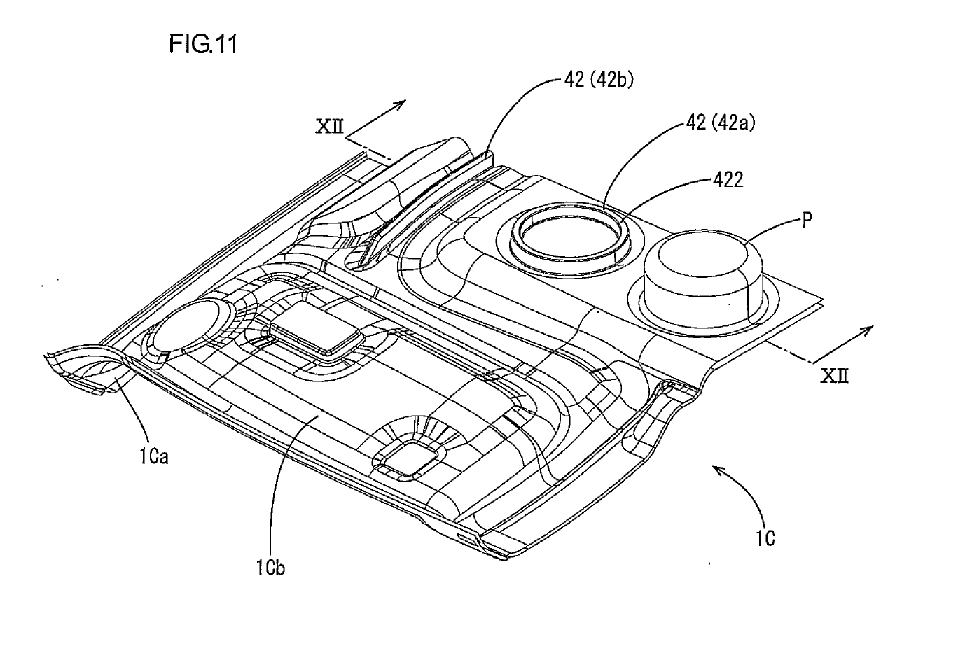

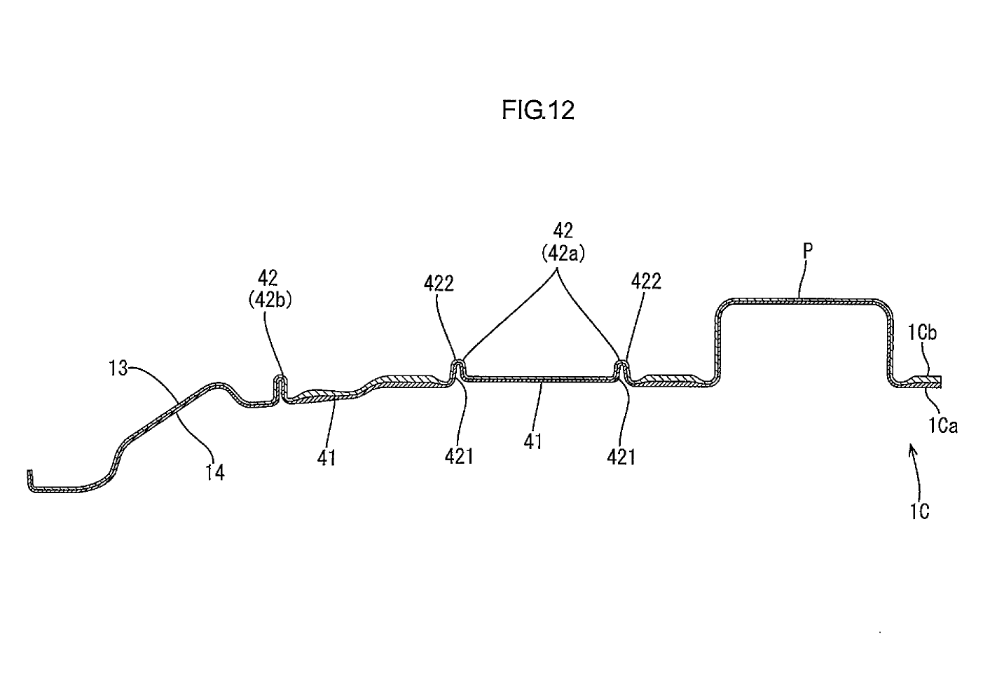

Next, a fourth embodiment according to the present technology will be described with reference to FIGS. 10 to 13. In this embodiment, a ceiling interior part 1C of a vehicle will be described similarly to the first embodiment. Similarly to the first embodiment, the ceiling interior part 1C of this embodiment includes the porous fiber base member 13 on a rear surface 1Cb side and the skin 14 sheet on a design surface 1Ca side. The porous fiber base member 13 is obtained by expanding a thermoplastic expansion fiber sheet.

The ceiling interior part 1C includes a mold portion 42a (42) having a plan view ring shape. The mold portion 42a includes a deep ring-shaped recess portion 421 having an opening on a design surface 1Ca. The mold portion 42a includes a ring-shaped projection 422 on a rear surface 1Cb and the projection 422 projects from the main sheet portion 41 outwardly (toward an upper side in a vehicular interior).

In this embodiment, the projection 422 positons a lighting device (an example of mounting member) 8 as a stopper.

The lighting device 8 supplies light from the rear surface 1Cb side of the ceiling interior part 1C toward the design surface 1Ca side and illuminate a vehicular interior with transmission light 84 transmitted through the ceiling interior part IC. The lighting device 8 includes an LED (a light source) 81, a casing 82, and a flange 83. The LED 81 emits light toward the rear surface 1Cb of the ceiling interior part 1C and is arranged in the casing 82. The casing 82 has a substantially columnar outer shape. The flange 83 projects outwardly from an outer peripheral surface of the casing 82.

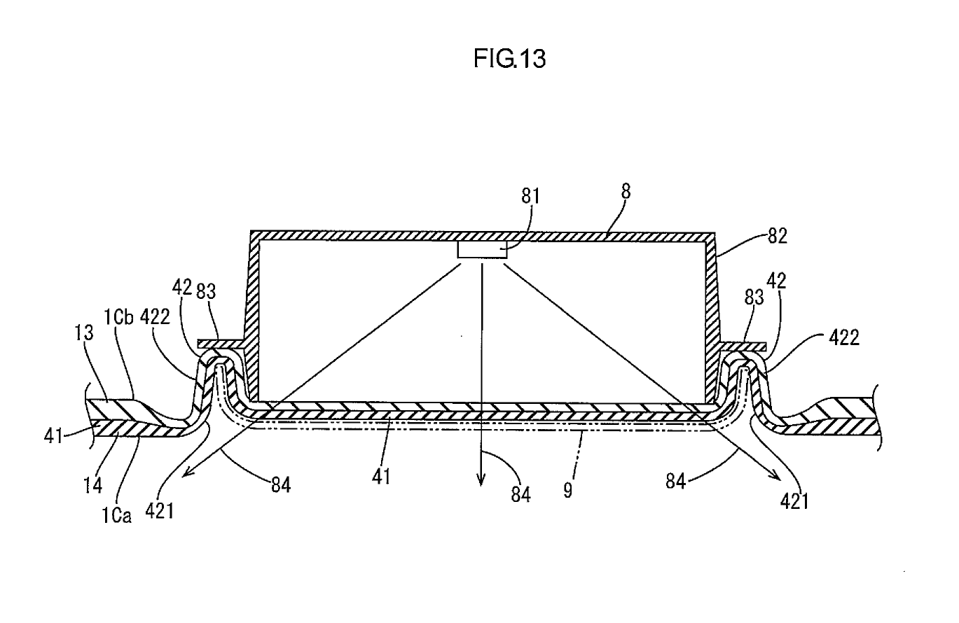

As illustrated in FIG. 13, the casing 82 is open on a lower side thereof. The lower edge portion of an outer peripheral wall of the casing 82 is put inside the projection portion 422 such that the flange 83 is put on the projection portion 422.

The mold portion 42 of this embodiment includes the projection portion 422 and the recess portion 421 and the projection portion 422 is on an opposite side from the design surface 1Ca (on the rear surface 1Cb). The recess portion 421 on the design surface 1Ca side is a ring-shaped deep groove and accordingly, the projection portion 422 on the rear surface 1Cb side has steep inclined side walls. According to such a configuration, the flange 83 is easily put on the projection portion 422 and stably positioned thereon. The projection portion 422 and the flange 83 of the lighting device 8 are fixed to each other with fixing means such as adhesive or screws, which are not illustrated.

In this embodiment, the projection portion 422 of the mold portion 42 may be used for mounting the mounting part of the lighting device 8.

The ceiling interior part 1C includes a circular main sheet portion 41 inside the ring-shaped projection portion 422. As illustrated in FIG. 13, a light transmission decoration sheet 9 may be attached on the circular main sheet portion 41 from the design surface 1Ca side. The decoration sheet 9 is attached on the design surface 1Ca of the main sheet portion 41 and on an inner surface of the side wall of the recess portion 421. The decoration sheet 9 extends to a bottom portion of the recess portion 421. The decoration sheet 9 is layered on the skin 14 via an adhesive agent layer. With such a decoration sheet 9, the light from the lighting device 8 is colored by the decoration sheet and design is improved.

The ceiling interior part IC of this embodiment further includes an elongated mold portion 42b that is for reinforcement and extends in the vehicular front-rear direction.

The ceiling interior part IC may include another mold portion P having a recess portion. The recess portion of the other mold portion P has an opening width greater than a depth.

### Other Embodiments

The present invention is not limited to the embodiments as described above with reference to the drawings. For example, the present invention may include following embodiments.

(1) The present invention may be applied to an interior part other than the ceiling interior part such as a door trim.

(2) The mold portion including the recess portion and the projection portion may be formed in the vehicular interior part in a linear shape or a curved shape.

(3) The mold portions including the recess portions and the projection portions may have the same width or may have different widths.

1. A vehicular interior part comprising:
a porous fiber base member made of an inorganic fiber sheet, thermoplastic resin, and a foaming agent;
a skin attached on one surface of the porous fiber base member and constitutes a design surface; and
a mold portion included in a part of the porous fiber base member and the skin that are attached to each other,
the mold portion having a recess portion on a skin surface side and a projection portion on a side opposite from the skin surface side, the recess portion having an opening on the design surface and having a depth equal to or greater than an opening width of the recess portion.

2. The vehicular interior part according to claim 1, wherein
the recess portion has a bottom width x, a depth h, and an opening width w satisfying a following expression:
(x+2 h)/2≦1.67 w.

3. The vehicular interior part according to claim 2, wherein the mold portion includes at least two mold portions that are arranged at an interval L defined by a following expression:
L≧(x+2 h−1.67 w)/1.2.

4. The vehicular interior part according to claim 1 being used as a ceiling interior part of a vehicular interior.

5. The vehicular interior part according to claim 1, wherein the mold portion holds a decoration part in the recess portion.

6. The vehicular interior part according to claim 5, wherein the decoration part is a light guide member.

7. The vehicular interior part according to claim 1, wherein the projection portion receives a mounting member.

8. The vehicular interior part according to claim 1, wherein
the recess portion has a bottom width and an opening width and the bottom width is smaller than the opening width.

9. The vehicular interior part according to claim 8, wherein
the recess portion has two facing side wall portions and lines extended from the side wall portions cross and form an angle of 40 degrees or less.

10. The vehicular interior part according to claim 1, wherein the mold portion includes multiple mold portions that are elongated narrow grooves and cross each other.

11. The vehicular interior part according to claim 1, wherein the mold portion is an elongated narrow groove and the elongated narrow groove has a through hole at an end portion thereof.

12. The vehicular interior part according to claim 1, wherein the foaming agent is heat foaming agent.

13. The vehicular interior part according to claim 1, wherein the depth of the recess portion is greater than a thickness of the vehicular interior part.
